(19) United States
(12) Patent Application Publication
(10) Pub. No.: US 2010/0209203 A1
(43) Pub. Date: Aug. 19, 2010

(54) DRILL SYSTEMS, DRILL INSERTS AND METHODS

(75) Inventor: Yuan Cao, Montreal (CA)

Correspondence Address: HAHN LOESER & PARKS, LLP, One GOJO Plaza, Suite 300, AKRON, OH, 44311-1076, US

(73) Assignee: ALLIED MACHINE & ENGINEERING CORP., Dover, OH (US)

(21) Appl. No.: 12/704,894

(22) Filed: Feb. 12, 2010

Related U.S. Application Data
(60) Provisional application No. 61/152,515, filed on Feb. 13, 2009.

(30) Foreign Application Priority Data
Feb. 12, 2010 (US) PCT/US10/24018

(51) Int. Cl. B23B 27/16; B23B 51/02; B23B 35/00

(52) U.S. Cl. 408/1 R; 408/224; 408/231; 408/200

(57) ABSTRACT

A drill system and cutting insert geometry is provided, with the system comprising a drill body having at least one cutting insert, with the at least one cutting insert is formed with at least one cutting edge, and has a first negative clearance surface and a second positive clearance surface, wherein the first negative clearance surface plastically deforms the surface of a work piece to produce a smooth surface finish and substantially reduce or eliminate chatter during a machining process.

### CROSS-REFERENCE TO RELATED APPLICATIONS/INCORPORATION BY REFERENCE

This U.S. patent application claims priority to and the benefit of U.S. Provisional Patent Application Ser. No. 61/152,515, filed on Feb. 13, 2009, which is incorporated herein by reference in its entirety.

### TECHNICAL FIELD

The present invention generally relates to a drill system, and drill inserts, such as for drilling, milling, turning or other metal cutting applications, wherein the drill system geometry increases stability and reduces chatter in the drilling operation.

### BACKGROUND

Twist type drills have been used for many years, generally being formed of hardened steel. Solid carbide drills provide desired strength characteristics for machining, but have various limitations. There have also been drilling tools developed with replaceable drilling inserts. Indexable drills utilize inserts with cutting edges on two or more sides, such that the inserts are indexable to position a new cutting edge for cutting as one cutting edge becomes worn. The inserts may be seated in pockets on the cutting end of a drill body. The pockets may have a shape corresponding to at least a portion of the shape of the insert. The inserts may be indexable, meaning that when the cutting edges wear in operation, the inserts may be removed or loosened from their position on the drill body, then rotated, or indexed, in a predetermined manner to enable use of additional cutting edges on the insert. At least one cutting geometry is associated with the insert, which may be on two or more index locations, such as for example an approximately square, rectangular or other quadrilateral shaped insert having cutting geometry at two or four positions, an approximately triangular insert having cutting geometry at three positions, or other suitable shapes. Inserts may be made of a material harder and/or denser than the drill body. Indexable inserts may be capable of cutting feeds and speeds greater than a conventional twist type drill. Inserts may be carbide materials or similar materials that have a suitable hardness or may be hardened to provide a cutting edge with a hardness greater than the material being drilled.

An indexable drill may operate at a faster rotational speed, cutting greater surface area than a “spade type” drill, allowing a faster feed advancement. Another advantage of the indexable drill over a conventional spade drill, solid carbide drill, or conventional twist drill, is that the inserts are consumables. Instead of regrinding the cutting edge, the insert may be indexed to a new cutting edge and then thrown away when all the cutting edges are worn. At the same time, indexable type drills can have problems due to non-uniform cutting forces in the operating drill. In the past, the drill may be held in the desired cutting path by a machine spindle, and the accuracy may be dependant on the rigidity of the machine and spindle, and the setup holding the part.

Machine tools, including drilling tools, may be subject to various vibrations, such as due to unbalance, gear and bearing errors, as well as chatter phenomena. The occurrence of unbalance from gear and bearing errors are generally overcome in correcting or offsetting such errors, but the occurrence of chatter of the machine tool is a different kind of problem. The causes underlying the mechanism of chatter are still not fully understood, which makes it difficult to control. Chatter can occur under different circumstances, based on different variables that may contribute to it. The type of material being machined can bear upon whether chatter of the machine tool occurs for example. Chatter may be considered self-excited or “regenerative” vibrations in machining. These are vibrations such as chatter that feed themselves simply as a result of the dynamics of the cut. For example, when oscillations in a machine tool interact with the part's surface, chatter can result. Further, individual systems of spindle, tool and toolholder can create repeatable harmonic speeds where cutter oscillation and surface waves can interact to cause chatter or cleanly bypass one another to keep the cut quiet and the cutting load level and smooth. Though under some circumstances it may be possible to machine at harmonically stable cutting conditions that permit more productive cutting, this may not suit desired cutting speeds or other desired machining characteristics. Differences can also be found in the type of machining process, such as between milling or turning processes as compared to hole drilling processes, but in each of these processes, it is desired to minimize or eliminate chatter. Minimizing chatter can provide for faster machining, with less tool wear, which leads to reduced costs of machining. In hole drilling operations, chatter can lead to errors in hole roundness, hole straightness and smoothness for example, and can adversely affect tool life.

In drilling operations, chatter may result from torsional-axial coupling, a mechanism which can be inherent to the tool, wherein as the drill cuts, it twists in reaction to the load on its cutting edges. Although the load is torsional, the distortion of the drill also has an axial counterpart. The twisting causes the drill to want to get longer, but this is resisted by the thrust on the drill and by the axial stiffness of the drill. As a result, the opposing forces being the torsional force and the resistance force that fights this extension may cause the drill to flex back and forth between these forces. Chatter can thus cause tool wear resulting from the impacts of the tool with the hole, and can also accelerate wear of other machine components which is undesirable.

Drills that are not balanced can cause chatter. Because indexable inserts may not be two flute effective and may not be uniform, prior indexable drills have been difficult to balance. In the past, indexable inserts have been honed or made with flat ground cutting edges to protect the edges from chatter or movement common in the prior art indexable drills. For this reason, more power was required for past drills with the honed or flat ground insert edges.

It would therefore be worthwhile to avoid the creation of chatter in drilling operations to alleviate the problems produced thereby. It would be worthwhile to be able to control chatter in either twist drills or indexable drills using one or more replaceable inserts.

### SUMMARY OF THE DISCLOSURE

The present invention relates to a drill tool comprising a drill body having a longitudinal axis, and a first end opposite a second end, with the first end including at least two cutting edges, wherein the at least two cutting edges each have a clearance surface, each clearance surface extending radially, wherein the clearance surfaces are formed to have at least a portion thereof as a negative clearance surface that loads up during a drilling operation and tends to burnish the machined surface and stabilize the tool to reduce chatter. The negative clearance surface may be provided with a wear coating to reduce wearing thereof during a machining operation. In this example, providing at least a portion of the clearance surface as a negative clearance causes the clearance surface to rub more against the bottom of the hole, which has a damping effect that reduces chatter. In a further example, the invention relates to an indexable cutting insert for use in an indexable drilling tool, wherein the insert has at least one cutting edge with a clearance surface, wherein the clearance surface is formed to have at least a portion as a negative clearance surface. The negative clearance surface may be formed adjacent a positive primary clearance surface, and in examples, the negative clearance surface may also be provided adjacent the rake face or a T-land surface, wherein the T-land surface may be neutral or negative.

The invention further relates to an indexable drill system comprising a drill body having a longitudinal axis, and having a central cutting system positioned along the longitudinal axis, the central cutting system being selected from the group consisting of a cutting insert, a solid carbide cutting member or combinations thereof. The central cutting system may be a blade type cutting insert, or may include a replaceable holder body in which a replaceable cutting insert is selectively positioned. The drill system may further comprise at least one indexable insert positioned outboard of the central cutting system, wherein the at least one indexable insert includes at least one cutting edge with a clearance surface, wherein at least a portion of the clearance surface is formed as a negative clearance surface.

The invention further relates to a method of reducing chatter and vibration in a drilling operation, comprising providing a drilling system having a longitudinal axis, and a first end opposite a second end, with the first end including at least two cutting edges. The at least two cutting edges each have a clearance surface, with each clearance surface extending radially. The clearance surfaces are formed to have at least a portion thereof as a negative clearance surface that loads up during a drilling operation and acts to burnish the machined surface to produce a damping effect that reduces chatter and stabilizes the tool.

### BRIEF DESCRIPTION OF THE DRAWINGS

FIG. 1 is a perspective view of an indexable drill system according to an example of the present disclosure;

FIG. 2 is a first side view of the drill system of FIG. 1;

FIG. 3 is a second side view of the drill system of FIG. 1;

FIG. 4 is a perspective view of a portion of a wheel rim into which holes are machined using the drill system according to the invention as a example;

FIG. 5 is a cross-sectional view of a hole profile that may be formed by the drill system of FIG. 1;

FIGS. 6A-6D show views of an example of a first indexable insert usable in conjunction with the present disclosure;

FIGS. 7A-7E show views of an example of an alternative insert configuration;

FIGS. 8A-8E show views of an example of an alternative insert configuration;

FIGS. 9A-9E show views of an example of an alternative insert configuration;

FIGS. 10A-10D show views of an example of a prior art insert configuration; and

FIG. 11A shows a hole machined with an insert such as shown in FIG. 10, and FIG. 11B shows a hole machined with an insert according to an example of the invention.

### DETAILED DESCRIPTION OF THE DRAWINGS

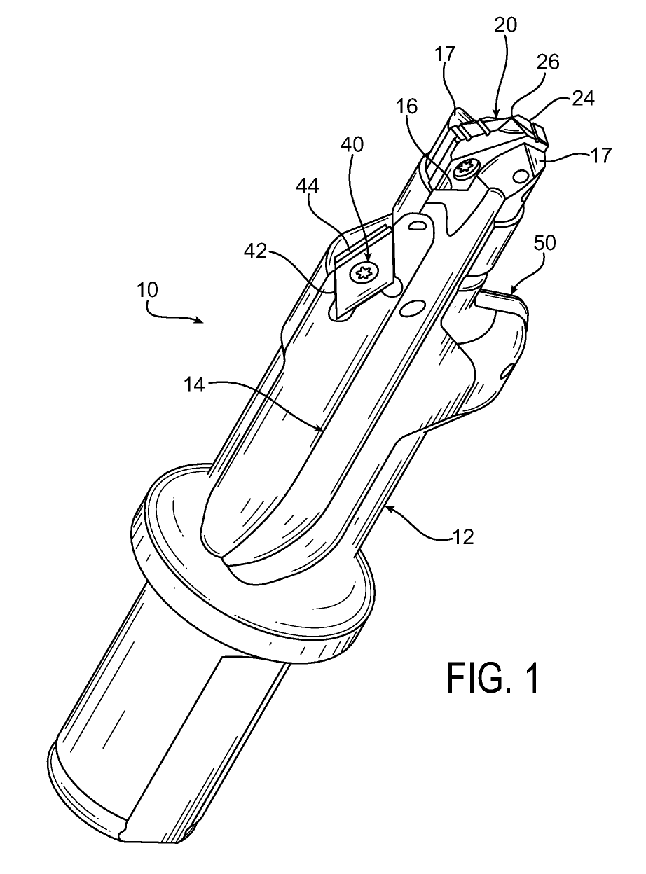

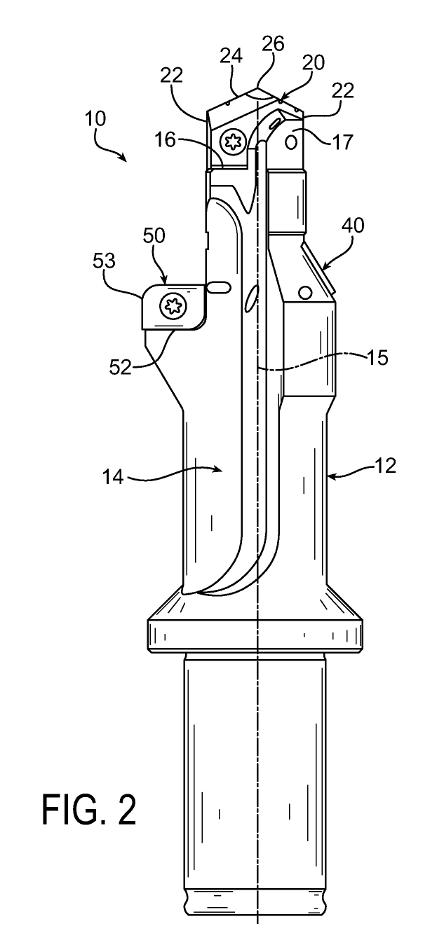

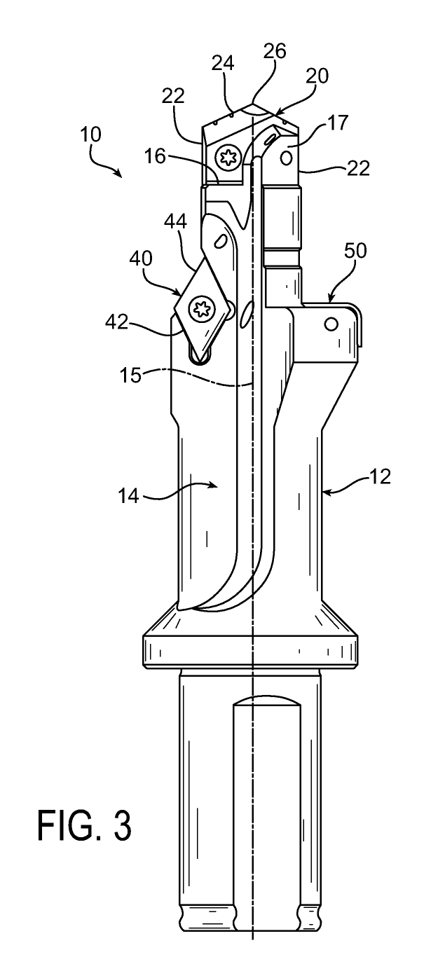

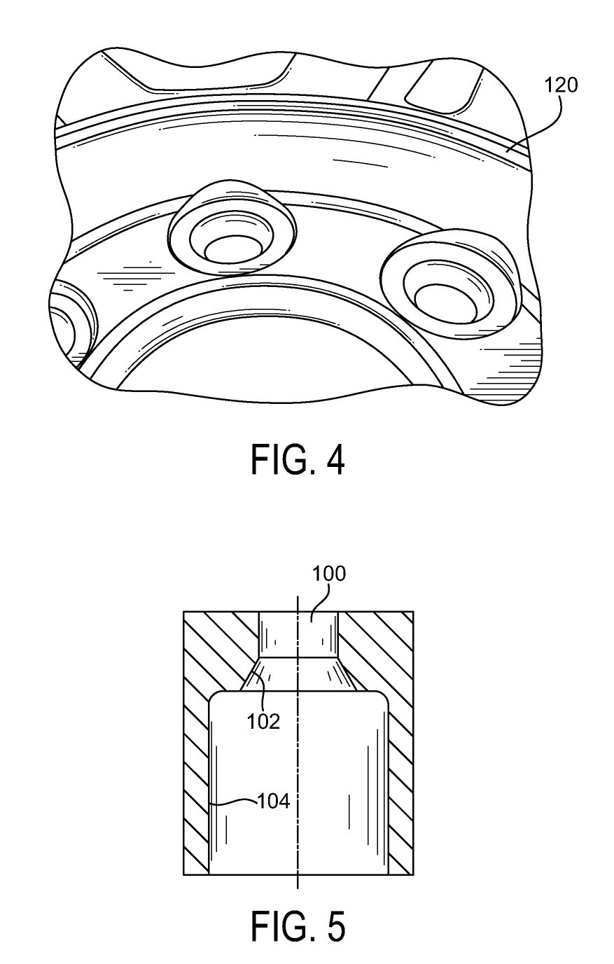

The invention relates to an indexable drill system, and indexable inserts, with various examples presently disclosed, wherein the drill system may utilize one or more inserts and/or indexable cutting inserts. In an example with reference to FIGS. 1-3, the drill system 10 may be used to form holes in a wheel rim 120 for example, such as shown in FIG. 4, and may produce a hole configuration as shown in FIG. 5. The hole configuration may include a through hole 100 formed by a central cutting system 20 as will be described, and a tapered section 102 formed by a first indexable insert 40, and a recess portion 104 formed by a second indexable insert 50. Although the drill system 10 as shown in this example includes these various cutting members, other drill configurations may incorporate the concepts of the invention, and may or may not include a central cutting system 20, and/or one or more indexable inserts such as 40 and 50. In general, the cutting members according to the invention are designed to minimize chatter or other undesired vibration during machining. The use of one or more indexable inserts allows the advantages of indexable inserts to be achieved while alleviating deficiencies of indexable drills. The drill system 10 provides increased performance efficiency, reduced cost of operation, and elimination of unnecessary further machining operations. The indexable inserts or other cutting members also allow for enhanced chip flow to allow high penetration rates and provide other advantages.

Referring now to FIGS. 1-3, the indexable drill 10 may comprise a drill body 12 for carrying the various inserts described hereafter. The lug hole drill holder 12 of this example is adapted to support varying included angles of indexable inserts. The lug hole drill 10 of this example includes a central cutting system 20, which may be a replaceable cutting insert such as a T-A or GEN2 insert as sold by Allied Machine & Engineering Corp. Other insert type configurations, such as provided by Allied Machine & Engineering Corp. or other manufacturers may be used, or other centrally positioned cutting systems or configurations may be usable and are contemplated in the invention. As an alternative to a blade type spade insert such as shown in this example, the central cutting system 20 could be a solid carbide cutting member or combinations thereof. The holder 12 may have one or more flutes 14 for evacuation of chips formed in the machining operation. A clamping or holder slot 16, which may extend across a portion of the diameter of the head portion of the holder 12 along the rotational axis 15 of holder 12. The holder slot 16 may have a bottom wall positioned in substantially perpendicular orientation relative to the rotational axis 15 of the holder 12. In an example, there may further be a locating boss or dowel pin (not shown) positioned precisely with respect to the axis 15 for precise positioning of the central cutting system 20. The central cutting system 20 and holding/supporting arrangement associated with holder 12 may be configured in another manner to achieve the corresponding functionality, to perform the desired drilling function in conjunction therewith. The central cutting system 20 shown in this example may have a point geometry comprising a plurality of cutting surfaces, which are precisely positioned with respect to the axis 15 of the holder 12 to minimize errors in a resulting drilling operation using assembly 10.

Further, in this example of holder 12, there may be provided a pair of clamping arms 17, which extend about holder slot 16. The clamping arms 17 may include apertures which accommodate screws as shown in the FIGS., to secure the central cutting system 20 in its position within the holder slot 16. In an example configuration, the holes may be threaded to engage screws and mate with screw holes formed in the central cutting system 20 in a predetermined manner to precisely locate the central cutting system 20 in a predetermined location within holder slot 16. Each of the clamp arms 17 may also include a lubrication vent on its top surface, which allows the application and flow of lubrication adjacent the cutting surfaces of the drill insert to facilitate the drilling operation. The clamp arms 17 may also include angled or curved surfaces, which facilitate chip removal via chip evacuating grooves 14 on each side of the holder 12. The seating surface 16 may be designed as a planar surface, as a V shape or other suitable configuration which corresponds to the bottom portion of the central cutting system 20.

The central cutting system 20 may form a spade drill blade, with side edges 22 of the blade being generally parallel with the rotational axis 15 of the holder 12 once the central cutting system 20 is positioned and secured with holder 12. When secured with holder 12, central cutting system 20 will also have a rotational axis which is coaxial with axis 15 of holder 12. The central cutting system 20 may have a width which forms the through hole 100 such as shown in FIG. 5. The drill insert 20 further includes cutting edges 24 on its upper surface in the form of an obtuse V-shape, with cutting edges 24 on each side of the axial center 26, also known as the dead center. The cutting edges 24 may include a plurality of cutting components, which cooperate together to provide the desired cutting surface 24 for the material and/or drilling application. In general, the central cutting system 20 is designed to cut when rotationally driven in conjunction with holder 12 in a predetermined direction, and is not reversible, although such alternative drilling system configurations are known to those skilled in the art and could be used in conjunction with the present invention if desired. The connection of central cutting system 20 to holder 12 may be similar to that described in co-owned U.S. Pat. No. 5,957,635, which is herein incorporated by reference, or in any suitable manner.

The indexable inserts 40 and 50 are positioned outboard of central cutting system 20. Insert 40 is positioned in an insert pocket 42 positioned adjacent the exterior of the drill holder body 12. The cutting insert 40 may be affixed in the insert pocket 42 such that a cutting edge 44 is capable of cutting tapered section 102 as shown in FIG. 5 for example. The indexable insert 50 may also be positioned in an insert pocket 52 positioned adjacent the exterior of the drill holder body 12. The cutting insert 50 may be affixed in the insert pocket 52 such that a cutting edge 53 is capable of cutting recess section 104 as shown in FIG. 5 for example. The pockets 42 and 52 may be shaped to correspond to at least a portion of the shape of the inserts 40 and 50 respectively.

The insert seats or pockets 42 and 52 are located relative to the central cutting system 20 in a predetermined manner. Further, the pockets 42 and 52 may be aligned with or rotated into or out of plane relative to the central cutting system 20 if desired. This may facilitate enhancing tool life of the drilling system 10 in that chip flow coming from the central cutting system 20 may be diverted from the inserts 40 and 50. Further, the chip flow coming from the inserts 40 and 50 can be designed to not interfere with the chip flow from the central cutting system 20, ensuring good chip evacuation from both inserts 40 and 50. Angling the position of inserts 40 and/or 50 may also facilitate opening the chip gullet and preventing clogging of the chips that could choke the drill system 10. Also, the rotation of the inserts may offset the multi-directional tool and cutting forces, decreasing harmonic vibrations and drill chatter. The inserts may also be positioned without any rotation or at desired inward or outward rotation angles, such as between zero to 25° for example.

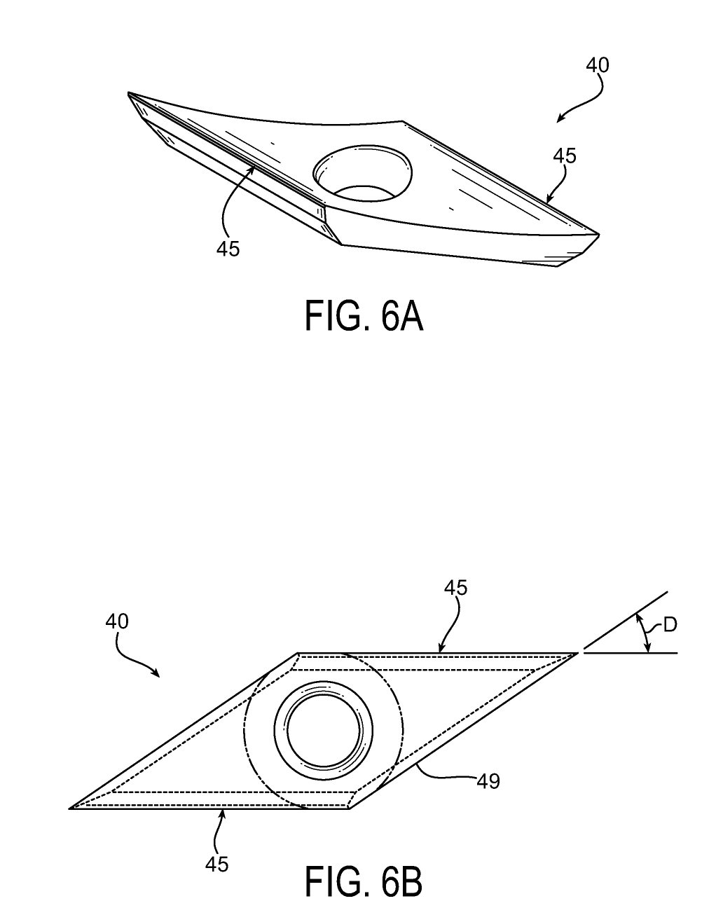

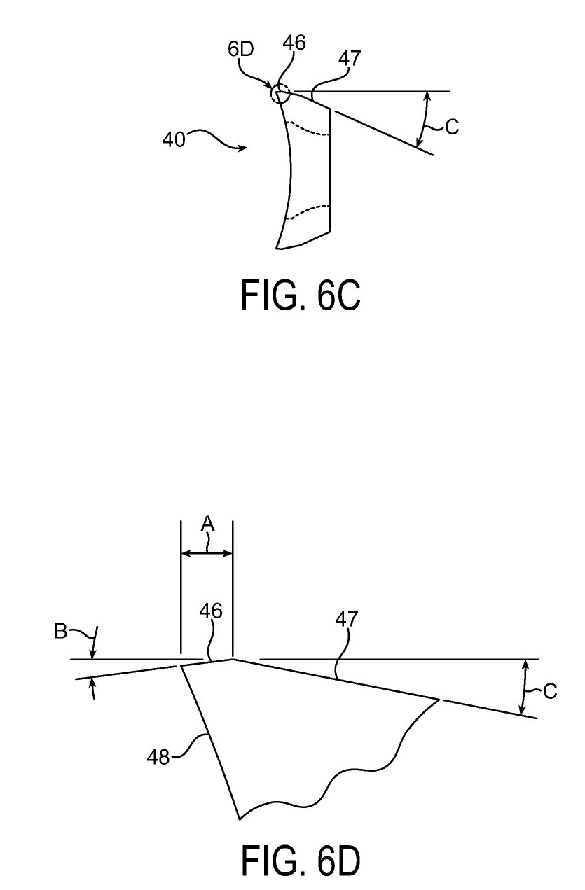

In this example, the drilling system 10 has indexable inserts 40 and 50 for forming separate portions of the hole to be machined. To reduce chatter or other vibrations during drilling, the inserts 40 and 50 may be formed with a negative clearance surface located at the I.C. insert main cutting edge, adjacent to positive clearance, that connects directly to a high rake angle cutting edge. In a further example, the negative clearance surface may be formed adjacent a 0° flat or negative T-land, or without T-land. Referring to examples of the indexable (I.C.) cutting inserts 40 and 50, such as shown in FIGS. 6-9, such characteristics will be described. An example of insert 40 is shown in FIG. 6, wherein the insert 40 includes first and second indexable cutting edges 45, disposed on opposing sides of the diamond-shaped insert 40. The cutting edges 45 include a negative clearance surface 46 having a width A, which may be any suitable dimension based on the size of the insert, and between one and fifteen thousandths of an inch for example. In the example shown, the width A may be six thousandths of an inch. The negative clearance surface 46 is angled at angle B, which may be an angle between 0° and 15° for example, with this angle B being 7° in the example as seen in FIG. 6D. The negative clearance surface 46 connects to a primary positive clearance surface 47 formed at angle C, which may be an angle between 2° and 25° for example, with this angle C being 11° in the example as seen in FIG. 6D. If desired, a secondary positive clearance surface may be provided, such as at an angle of between 5° and 35° for example, or in a particular example associated with an insert 40 of this type, an angle of 24°. The secondary positive clearance surface may facilitate preventing the tool from heeling during machining. In this example the rake angle of rake face 48 may be an angle between 10° and 50° for example, with this rake angle being 30° in the example as seen in FIG. 6D. In this example, the insert 40 is formed to have an angle D between cutting surface 45 and locating surface 49 as seen in FIG. 6B. Angle D may be any suitable angle, such as between 25° to 45°, or as shown in this example, an angle of 35°. This negative clearance feature is independent of primary clearance, rake angle, T-land (if provided) and cutting edge hone. In this example of an I.C. insert, the insert 40 is also formed to have a concave surface 82 which is located at the center of the I.C. insert and forms the insert rake angles of rake face 48.

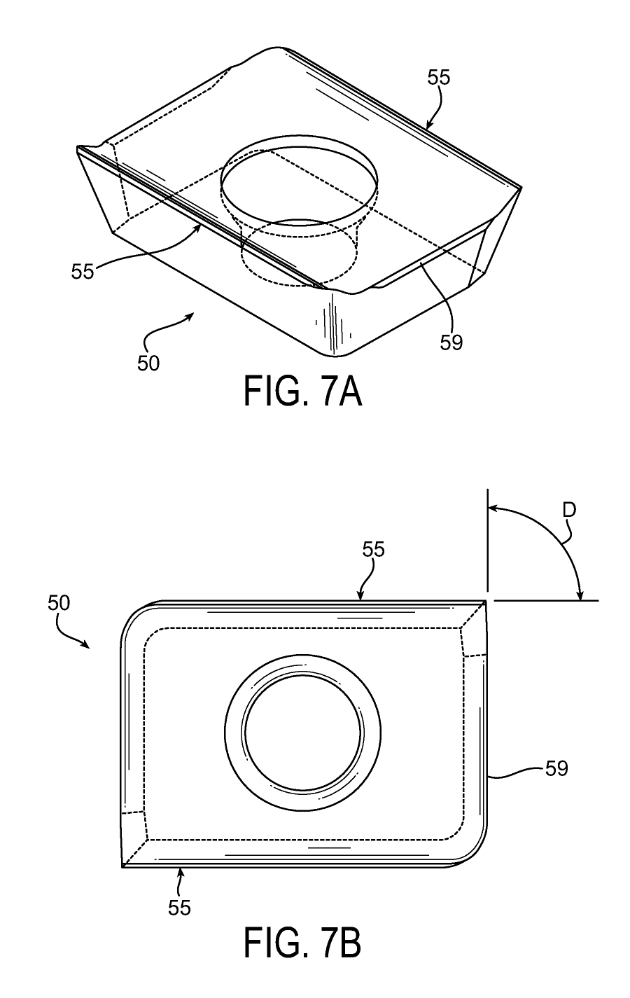

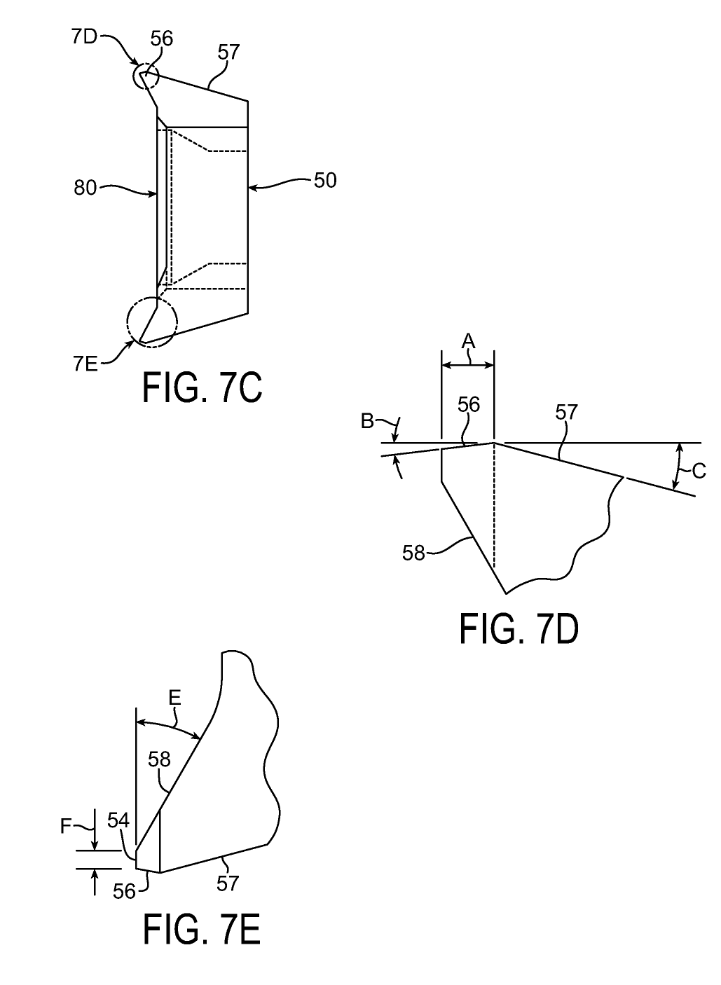

An example of insert 50 is shown in FIGS. 7A-7E, wherein the insert 50 includes first and second indexable cutting edges 55, disposed on opposing sides of the rectangular-shaped insert 50. There may be provided a protect wiper 59 adjacent the cutting edges 55 as seen in FIG. 7A, which may be formed substantially perpendicular to the cutting edge 55, which provides a wiping action to clear the back side of the insert 50 out. In this manner, the outer diameter of the insert 50 acts like a cutting edge, and tends to burnish the hole during machining. The cutting edges 55 include a negative clearance surface 56 having a width A, which may be any suitable dimension based on the size of the insert, and between 1 and 15 thousandths of an inch for example, and as in the prior example, is shown to be 6 thousandths of an inch. The negative clearance surface 56 is angled at angle B, which may be an angle between 0° and 15° for example, with this angle B being 7° in the example as seen in FIG. 7D. The negative clearance surface 56 connects to a primary positive clearance surface 57 formed at angle C, which may be an angle between 2° and 30° for example, with this angle C being 15° in the example as seen in FIG. 7D. In this example, no secondary positive clearance surface is provided. Further in this example, the rake angle E of rake face 58 may be an angle between 10° and 50° for example, with this rake angle being 30° in the example as seen in FIG. 7E. In this example, the insert 50 is formed to have an angle D between cutting surface 55 and locating surface 59, which may be an angle of between 80° to 100°, or as shown in this example, and angle of 90°, as seen in FIG. 7B. This negative clearance feature is independent of primary clearance, rake angle, T-land (if present) and cutting edge hone. In this example, the negative clearance surface 56 may be formed adjacent a T-land 54 having a width F, which may be of a dimension between 0 and 15 thousandths of an inch for example, with it being shown at 4 thousandths. The T-land 54 may be neutral or negative if desired.

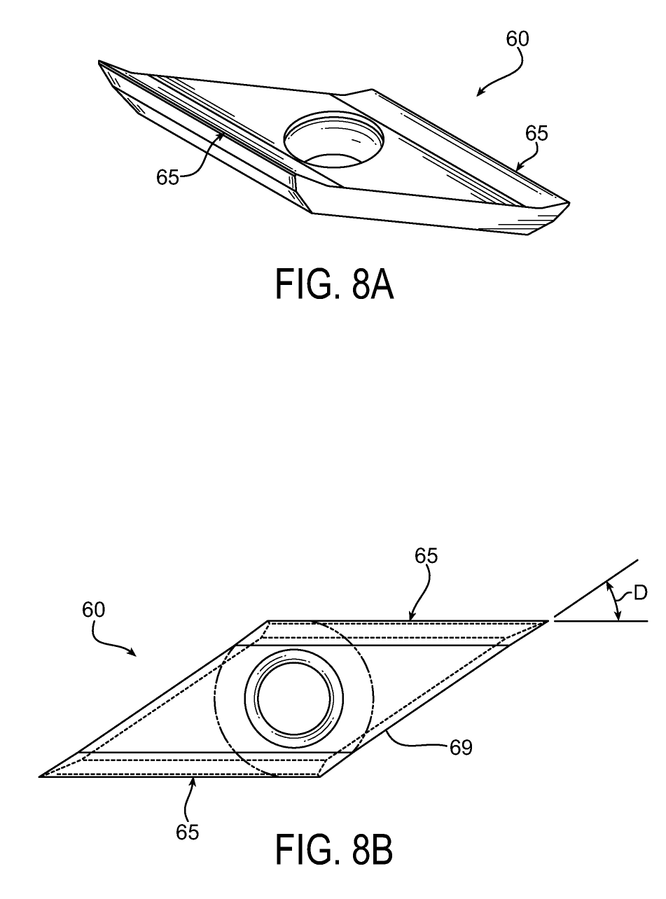

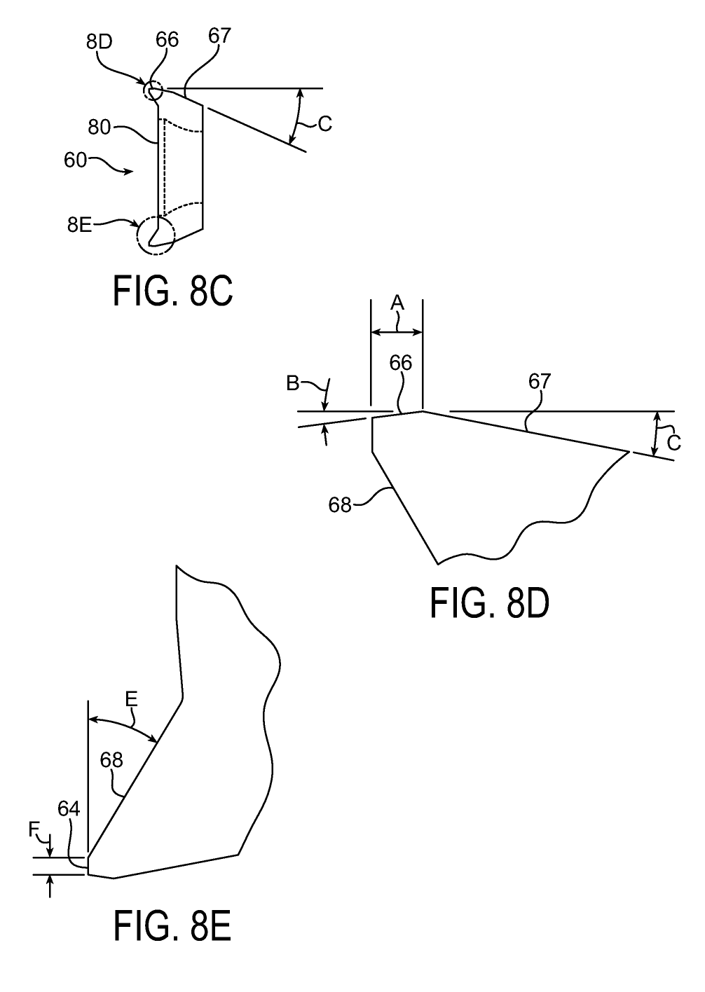

A further example of an IC insert usable in the tool 10 is shown at 60 in FIGS. 8A-8E, similar to IC insert 40 shown in FIG. 6. The insert 60 includes first and second indexable cutting edges 65, disposed on opposing sides of the diamond-shaped insert 60. The cutting edges 65 again may include a negative clearance surface 66 having a width A, which may be any suitable dimension based on the size of the insert, and between 1 and 15 thousandths of an inch for example, and being shown at 6 thousandths. The negative clearance surface 66 is angled at angle B, which may be an angle between 0° and 15° for example, with this angle B being 7° in the example as seen in FIG. 8D. The negative clearance 66 connects to a positive clearance surface 67 formed at angle C, which may be an angle between 2° and 25° for example, with this angle C being 11° in the example as seen in FIG. 8D. In this example the rake angle E of rake face 68 may be an angle between 10° and 50° for example, with this rake angle being 30° in the example as seen in FIG. 8E. In this example, the insert 60 is formed to have an angle D between cutting surface 65 and locating surface 69, which may be an angle of between 25° to 45°, or as shown in this example, an angle D of 35° as seen in FIG. 8B. This negative clearance feature is independent of primary clearance, rake angle, T-land (if present) and cutting edge hone. In this example, the negative clearance surface 66 may be formed adjacent a T-land 64 having a width F, which may be of a dimension between 0 and 15 thousandths of an inch, and being shown at 4 thousandths for example. The T-land 64 may be neutral or negative if desired.

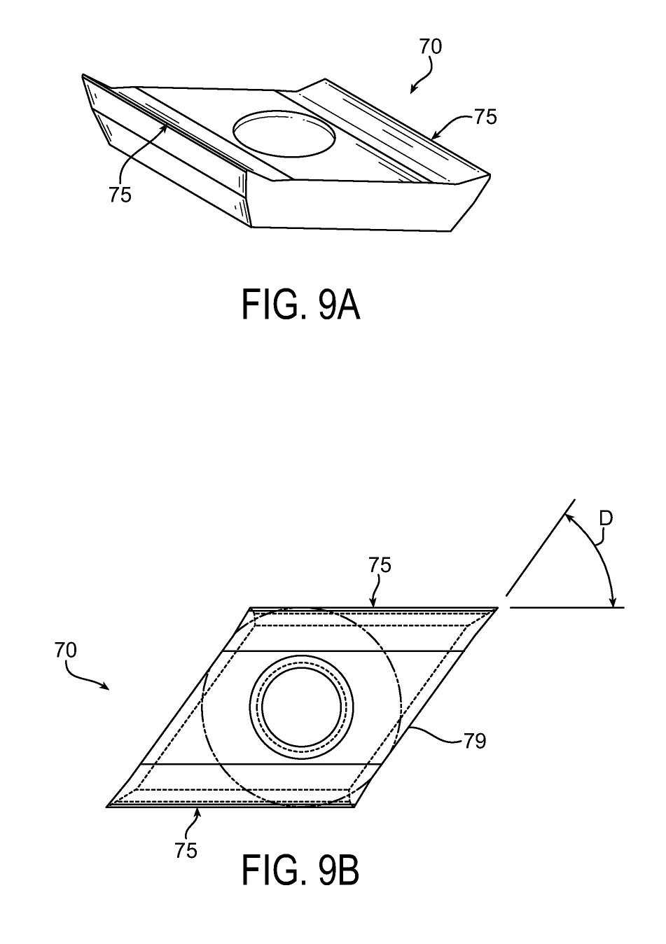

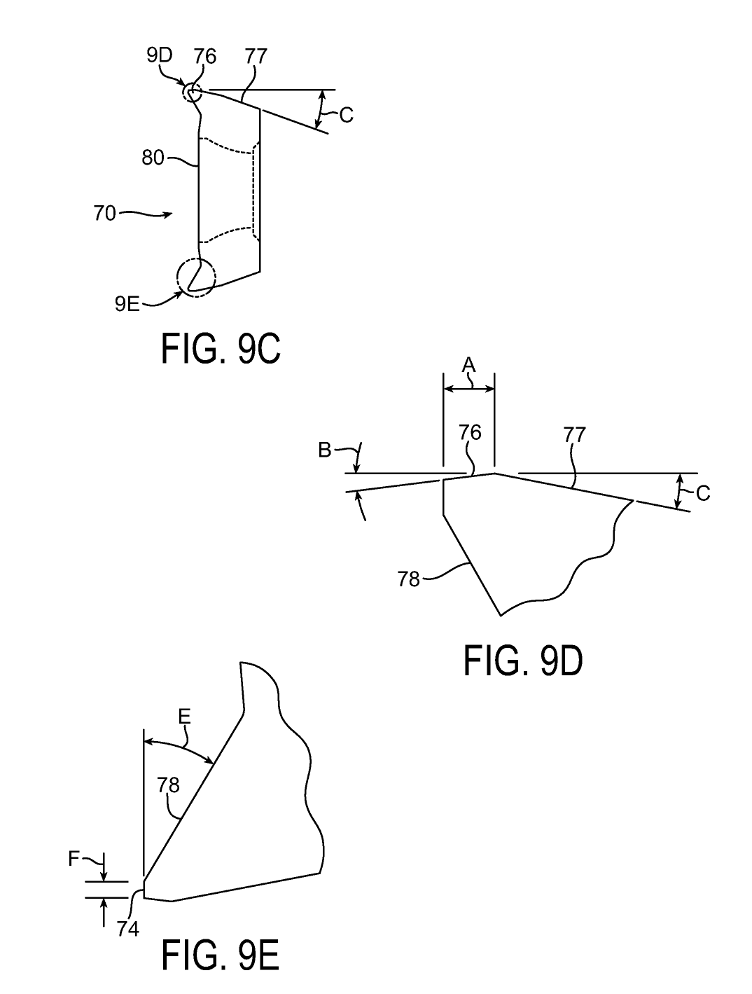

A further example of an IC insert usable in the tool 10 is shown at 70 in FIGS. 9A-9E, similar to IC insert 40 shown in FIG. 6. The insert 70 includes first and second indexable cutting edges 75, disposed on opposing sides of the diamond-shaped insert 70. The cutting edges 75 again may include a negative clearance surface 76 having a width A, which may be any suitable dimension based on the size of the insert, and between 1 and 15 thousandths of an inch, and being shown at 6 thousandths for example. The negative clearance surface 76 is angled at angle B, which may be an angle between 0° and 15° for example, with this angle B being 7° in the example as seen in FIG. 9D. The negative clearance surface 76 connects to a positive clearance surface 77 formed at angle C, which may be an angle between 2° and 25° for example, with this angle C being 11° in the example as seen in FIG. 9D. If desired, a secondary positive clearance surface may be provided, such as at an angle of between 5° and 35° for example, or in a particular example associated with an insert 40 of this type, an angle of 18°. The secondary positive clearance surface may facilitate preventing the tool from heeling during machining. In this example, the rake angle E of rake face 78 may be an angle between 10° and 50° for example, with this rake angle being 30° in the example as seen in FIG. 8E. In this example, the insert 70 is formed to have an angle D between cutting surface 75 and locating surface 79, which may be an angle of between 45° to 65°, or as shown in this example, an angle D of 55° as seen in FIG. 9B. This negative clearance feature is independent of primary clearance, rake angle, T-land (if present) and cutting edge hone. In this example, the negative clearance surface 76 may be formed adjacent a T-land 74 having a width F, which may be of a dimension between 0 and 15 thousandths of an inch, and is shown at 4 thousandths for example. The T-land 74 may be neutral or negative if desired.

In each of these examples, the I.C. inserts for included angles of 35°, 90° and 55° are shown, and other included angles could be used as desired. Similarly, the I.C. inserts may have other shapes, such as triangular, square or other quadrilateral shape, in addition to the diamond shaped and rectangular shaped inserts as shown in these examples. The I.C. inserts may have multiple cutting edges so as to be indexable, or simply provided as cutting inserts having a single cutting edge. In the examples of I.C. cutting inserts, such as shown in FIGS. 7D, 8D, and 9D, there is shown the negative cutting edge clearance surface, which can connect to straight rake angle, or as shown in FIG. 6D, the negative cutting edge clearance can connect to a radii rake angle. As seen in the examples of FIGS. 7E, 8E and 9E, the negative cutting edge clearance may be formed adjacent a T-land which is neutral or negative.

The cutting geometry of the I.C. inserts according to the invention may also utilize a concave feature in the center thereof, such as in the example of FIG. 6, or a drop island feature, such as shown in the side views of FIGS. 7C, 8C and 9C, wherein the drop island geometry 80 is located at the center of the I.C. insert, and is smoothly connected to the rake angle face in each side of the I.C. inserts. The concave and drop island configurations facilitate the flow of chips to evacuate the chips and allow high penetration rates.

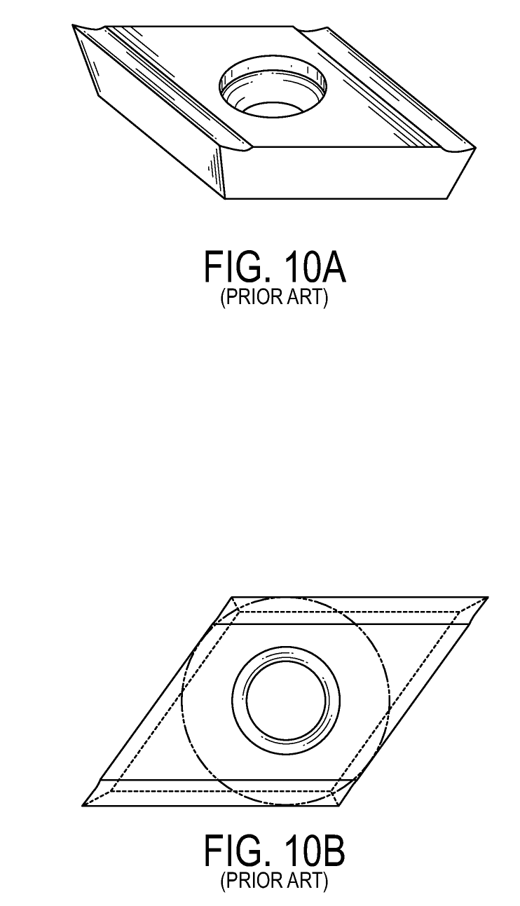

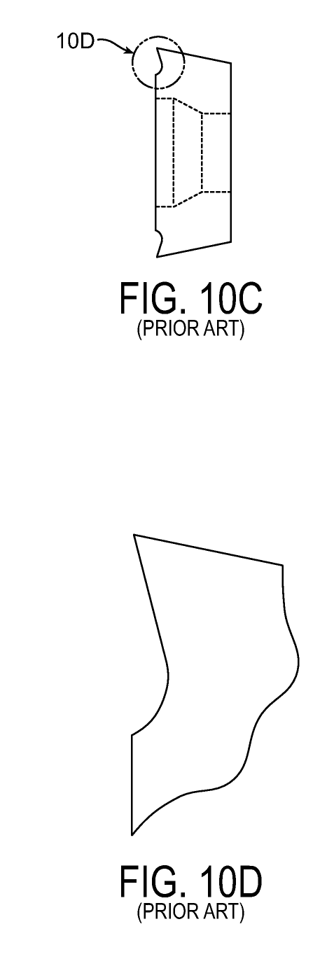

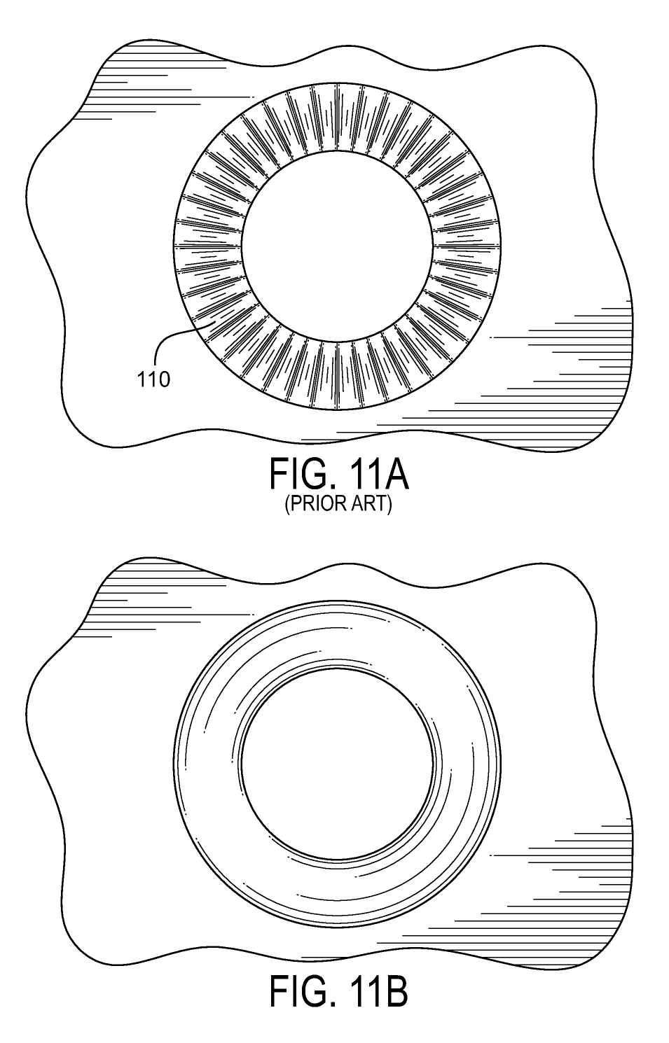

The negative clearance feature of the cutting geometry provides significant improvement for applications such as for the tool 10 shown in this example, which is used to produce lug holes in aluminum wheel rims or for machining in relatively soft materials such as aluminum, and minimizes chatter and vibrations as compared to prior geometries. As seen in FIGS. 11A and 11B, there is shown lug holes drilled in aluminum representative of wheel rims with the example I.C. inserts of FIG. 9 (FIG. 11B) according to the invention as compared with a prior art I.C. insert as shown in FIGS. 10A-10D (FIG. 11A), and it can be seen that waviness at 110 in FIG. 11A formed by chatter of the tool in the holes produced by the prior art I.C. insert of FIG. 10, is substantially eliminated in the holes produced by the I.C. insert 70 in the example of FIG. 9.

The negative clearance surface formed in examples of the I.C. inserts according to the invention presses against the work piece surface and the incremental surface contact between the cutting tool and work piece provide friction dampening characteristics. The use of a negative clearance surface angle of between 0° to 15° may be used for example, depending on the application, and can significantly reduce low frequency vibration and virtually eliminate chatter. The negative clearance geometry provides cutting and pressure rolling concurrently and allows the tool 10 to work in both older machines with lower RPM and newer machines with higher RPM, and provides good surface finish. The pressure rolling characteristics of the negative clearance surface tends to plastically deform the work piece surface layer, to produce a very smooth surface finish as seen in FIG. 11B, as compared to holes formed with a prior art system as in FIG. 11A. The surface peaks are pressed down, almost vertically, into the surface and the materials then flows into the valleys between the peaks. The resulting smooth surface occurs not because the peaks are bent into the surface, but because the material at the surface is plastically deformed or flows, and eliminates surface roughness. The following Table 1 shows a broader range of cutting parameters tested for the feature of the negative clearance surface as further example of the invention.

TABLE 1

| | |
|---|---|
| RPM (Blade | IPR |

| Max. SFPM). | 0.012 | 0.015 | 0.017 | 0.019 |
|---|---|---|---|---|
| 5400 (1002) | 1 hole | 1 hole | 1 hole | 1 hole |
| 6000 (1114) | 1 hole | 1 hole | 1 hole | 1 hole |
| 7000 (1299) | 1 hole | 1 hole | 1 hole | 1 hole |

The I.C. inserts according to the invention may also include the drop island feature as described, which allows the tool 10 to run at higher surface feet per minute rates, while maintaining chip formation in soft materials like aluminum. This increases penetration rates in a desired manner. In the example inserts, the high rake angle and top drop island and concave geometry, the chip deformation can be reduced due to the high rake angle and due to the drop island feature or concave feature of FIG. 6. The chip interference during the cutting process can be reduced to assist in evacuation of the chips from the cutting zone, to provide improved surface finish and substantially reduce or eliminate chatter.

In the I.C. inserts according to examples of the invention may be manufactured from materials such as high speed steel (HSS), carbide and other materials known in the art to have similar properties of hardness and edge sharpness retention. These base materials can then be coated with hard coating materials such as titanium nitride (TiN), titanium carbonitride (TiCN), and titanium aluminum nitride (TiAlN) to further add hardness and edge retention qualities or other suitable coatings. Various combinations of these or other suitable base materials and coatings can be used to accommodate various applications.

The invention may also utilize the features as described with reference to the I.C. inserts in association with other drilling systems, wherein a drill tool comprising a drill body having a longitudinal axis, includes a first end opposite a second end, with the first end including at least two cutting edges. The at least two cutting edges each have a clearance surface, with each clearance surface extending radially. The clearance surfaces are formed to have at least a portion thereof as a negative clearance surface that loads up during a drilling operation and tends to burnish the machined surface and stabilize the tool to reduce chatter. The negative clearance surface may be provided with a wear coating to reduce wearing thereof during a machining operation. In this example, providing at least a portion of the clearance surface as a negative clearance causes the clearance surface to rub more against the bottom of the hole, which has a damping effect that reduces chatter. The negative clearance surface may be formed adjacent at least one positive clearance surface, and in examples, the negative clearance surface may also be provided adjacent the rake face or a T-land surface, wherein the T-land surface may be neutral or negative.

While the invention has been illustrated and described in detail in the foregoing drawings and description, the same is to be considered as illustrative and not restrictive in character, it being understood that only illustrative embodiments thereof have been shown and described, and that all changes and modifications that come within the spirit of the invention described by the following claims are desired to be protected. Additional features of the invention will become apparent to those skilled in the art upon consideration of the description. Modifications may be made without departing from the spirit and scope of the invention.

What is claimed is:

1. A drill system comprising:
a drill body having a longitudinal axis, with at least two cutting edges, wherein the at least two cutting edges have at least one clearance surface, the at least one clearance surface extending radially, with each of the at least one clearance surface having at least a portion of the first clearance surface is a negative clearance surface, wherein the negative clearance surface plastically deforms the surface of a work piece to produce a smooth surface finish and substantially reduce chatter or vibration of the drill system during a machining process.

2. The drill system according to claim 1, further comprising at least one pocket for positioning at least one cutting insert therein, where the at least one cutting insert is formed with at least one cutting edge.

3. The drill system according to claim 1, wherein at least a second clearance surface is provided adjacent the first clearance surface, the second clearance surface being a positive clearance surface.

4. The drill system according to claim 1, wherein the negative clearance surface extends from the at least one cutting edge at an angle of between zero and fifteen degrees.

5. The drill system according to claim 2, wherein the at least one cutting insert is an indexable insert having at least two cutting edges, which are selectively disposed in said at least one pocket with one of the at least two cutting edges exposed for cutting during a machining process.

6. The drill system according to claim 2, wherein the at least one cutting insert is formed to have a shape selected from the group consisting of substantially diamond shaped, substantially rectangular shaped and substantially triangular shaped.

7. The drill system according to claim 2, wherein the at least one cutting insert has a T-land portion provided adjacent the negative clearance surface.

8. The drill system according to claim 7, wherein the T-land surface is a neutral or negative surface.

9. The drill system according to claim 1, further comprising a central cutting system associated with the drill body positioned along the longitudinal axis, and at least one cutting insert disposed radially outward of the central cutting system.

10. The drill system according to claim 1, further comprising at least two cutting inserts, each of the at least two cutting inserts including at least a first clearance surface, wherein at least a portion of the first clearance surface is a negative clearance surface.

11. The drill system according to claim 1, further comprising a central cutting system disposed along the longitudinal axis, and at least two cutting inserts disposed radially outward from the central cutting system, with the at least two cutting inserts formed with at least one cutting edge, and having at least a first clearance surface, wherein at least a portion of the first clearance surface is a negative clearance surface.

12. The drill system according to claim 2, wherein at least two cutting inserts are provided, each having at least one cutting edge, and at least a first clearance surface, wherein at least a portion of the first clearance surface is a negative and the at least two cutting inserts are different from one another.

13. The drill system according to claim 1, further comprising a central cutting system disposed along the longitudinal axis, and at least two pockets for positioning at least two cutting inserts therein, each of the at least two cutting inserts formed with at least one cutting edge, and having at least a first clearance surface, wherein at least a portion of the first clearance surface is a negative clearance surface, and wherein the central cutting system forms a through hole through a workpiece, and one of the at least two cutting inserts forming a tapered section, and the second of the at least two cutting inserts forming a recessed portion in the workpiece.

14. The drill system according to claim 13, wherein the workpiece is an aluminum wheel rim, and the drilling system produces a lug hole in the aluminum wheel rim.

15. The drill system according to claim 2, wherein the at least one cutting insert includes a drop island portion or concave portion in the central area of the at least one cutting insert, the drop island or concave portion allowing machining to run at higher surface feet per minute rates, while maintaining chip formation of the workpiece material.

16. The drill system according to claim 1, wherein the negative clearance surface includes a wear coating to reduce wearing thereof during a machining operation.

17. A cutting insert comprising a body formed with at least one cutting edge, and has a first negative clearance surface and a second positive clearance surface, wherein the first negative clearance surface plastically deforms the surface of a work piece to produce a smooth surface finish and substantially reduce chatter during a machining process.

18. The cutting insert according to claim 17, wherein the cutting insert includes a drop island portion or concave portion in the central area of the cutting insert, the drop island or concave portion allowing machining to run at higher surface feet per minute rates, while maintaining chip formation of the workpiece material.

19. The cutting insert according to claim 17, wherein the negative clearance surface extends from the at least one cutting edge at an angle of between zero and fifteen degrees.

20. A method of reducing chatter and vibration in a drilling operation, comprising providing a drilling system having a longitudinal axis, and a first end opposite a second end, with the first end including at least two cutting edges, wherein the at least two cutting edges each have a clearance surface, with each clearance surface extending radially, and at least a portion of the clearance surfaces are formed to have at least a portion thereof as a negative clearance surface which loads up during a drilling operation and acts to burnish the machined surface to produce a damping affect that reduces chatter and stabilizes the drilling tool.
